(19) United States
(12) Patent Application Publication
(10) Pub. No.: US 2002/0151399 A1
(43) Pub. Date: Oct. 17, 2002

(54) Compression belt for CVT having a crowned strut edge wherein the radius is determined by the maximum allowable contact stress and is located so that the contact point remains close to the rocking radius of the struts

(76) Inventor: Philip J. Mott, Dryden, NY (US)

Correspondence Address: BROWN & MICHAELS, PC, 400 M & T BANK BUILDING, 118 NORTH TIOGA ST, ITHACA, NY, 14850, US

(21) Appl. No.: 10/119,823

(22) Filed: Apr. 10, 2002

Related U.S. Application Data
(60) Provisional application No. 60/284,162, filed on Apr. 16, 2001.

(51) Int. Cl. F16G 1/00; F16G 5/00

(52) U.S. Cl. 474/242; 474/201

(57) ABSTRACT

A compression belt for a CVT having multiple variable pulleys comprises a plurality of interconnected load blocks, each having a unitary construction and a crowned strut edge for contacting and mechanically linking the pulleys of the CVT, wherein the radius of the crown is determined by the maximum allowable contact stress of the material from which the strut is manufactured, and the radius is located such that the contact point of the strut with the pulley remains close to the rocking radius of the strut.

### BACKGROUND OF THE INVENTION

1. Field of the Invention

The invention pertains to the field of compression or push-type belts or chains for continuously variable transmissions. More particularly, the invention pertains to a compression belt comprising a crowned strut edge, for use in a continuously variable transmission.

2. Description of Related Art

In recent years, significant research and development has been devoted to a practical continuously variable transmission (CVT) for automotive applications. A CVT provides a portion of the mechanical link between the vehicle engine and the drive wheels used to control the torque output of the engine.

A CVT generally operates by the use of multiple variable pulleys mounted on parallel axes, connected by an endless chain-belt, typically comprising metal or elastomeric materials. A first variable pulley is situated on an input shaft and is mechanically driven by the vehicle engine. A second variable pulley is mounted on an output shaft and is driven by the first pulley through the chain-belt. The second pulley acts through additional drive components to transmit torque to the vehicle drive wheels. Each pulley rotates about an independent shaft and is formed by the cooperation of two pulley sheaves, one of which is axially movable in a direction opposite from the other. The sheave pairs, mounted on the pulley axis, form the inner faces of the pulley. The profiles of the inner faces are generally inclined, such that the two sheave inner faces tend to converge toward the pulley axis. When at least one of the sheaves is movable axially relative to the other sheave, variation in the distance separating the opposing inner faces can be obtained.

The contact surface of the chain or belt which serves as a power transmission element engages the inner faces of the pulley sheaves and transmits torque by friction. Most conventional load block configurations include load blocks having a contact surface which is a plane surface. In such configurations, the contacts with conventional conical sheaves are line contacts (i.e., where the contacted area is a band) and not point contacts. As the chain belt passes over the pulley, the point where the load block or link articulates is defined as the pitch-line. The pitch (p) is the distance between successive articulations.

During the operation of the CVT, a movable sheave on the first pulley may be translated axially along the pulley axis so as to increase or decrease the distance separating the sheave inner faces. Similarly, a movable sheave on the second pulley decreases or increases the distance separating the sheave inner faces. Accordingly, as the distance separating the primary pulley inner faces is increased, the distance separating the secondary pulley inner faces is caused to be decreased in order to provide mechanical and hydraulic balance.

As the sheave members are translated along the axis of the pulley, the effective pulley radius is increased or decreased due to the inclined inner face of the sheave. The location of the chain-belt articulation or neutral axis (i.e., the pitch-line) around the intermediate circumference of the pulley inner faces defines the effective radius of the pulley. As the sheave inner face separation distance of the first pulley decreases, the chain-belt is forced to adopt its contact at a larger radial distance as it rises up along the inclined sheave inner face and the pitch-line is changed. Simultaneously, the effective radius of the second pulley is proportionately decreased by the separation of the pulley sheaves therein. Similar to the first pulley, the chain-belt is forced to adopt its contact at a smaller radial distance and the pitch-line is changed. Thus, the ratio of the pulley radii may be varied continuously to obtain the desired final drive ratio for the specific vehicle operating conditions. Typically the inclined inner pulley sheave faces are generally linear (conical). However, curved profile inner sheave faces also are used to reduce the overall profile of the CVT pulleys.

In the past, the most common configuration for the chain-belt which mechanically links the pulleys has been a conventional chain-belt having a plurality of interconnected load blocks, and may have a variety of link and block configurations, e.g. pin or rocker chains, link belts, etc. Such a chain transmits power in a conventional way by transmitting a pulling force through the links and pins of the chain. This type of chain has drawbacks in CVT service, because of the very large compression force required to transmit power from the sheaves to the transmission belt. When a conventional pull-type link chain is used in a CVT, this compressive force can deform the pins and links of the chain.

A compression belt, which is a kind of power transmission element which transmits force by pushing rather than pulling, has become important in CVT applications. A compression is made up of a very large number of relatively thin elements called “load blocks” or “struts” or “force elements”, which are generally solid across their width, and are held in place by a continuous laminated steel band. The force is transmitted by the line of struts, each pressing on the next block, and so on.

It is not uncommon for the contact surfaces with pull-type chains to be of arcuate or “crowned” shape—for example, see U.S. Pat. No. 5,328,412, “Apparatus and Method for Generating a Variable Pulley Sheave Profile”. Compression belts using split load blocks, such as Forster, U.S. Pat. No. 5,318,484, “Metal V-Belt Drive” or Yagasaki, U.S. Pat. No. 6,110,065, “Metal V-Belt” have used crowned sides on the split half-blocks, which are designed to rock around the axis of the belt, opening and closing the gaps between the top and bottom of the half-blocks, so as to ease the releasing of the belt as it leaves the sheaves. The crowning of the sides of the half-blocks in such a design allows the necessary rocking movement of the half-blocks as the gaps open and close. Also, prior art solid struts have crowned the upper surface of the load block, where it contacts the steel band, to provide a self-centering force for the steel bands.

However, the crowned contact-surface strut configuration has not previously been used with compression style CVT belts, despite the many patents which have issued on such belts. To the contrary, all of the compression style CVT belts of the prior art known to the inventor which use solid load blocks utilize straight-sided load blocks or struts to contact the sheaves, as is shown in the VanDoome's CVT belt shown in U.S. Pat. No. 6,086,499, “Continuously Variable Transmission”.

Due to sheave deflection and strut deflection, with such straight-sided load blocks, the point of contact can be either at the top of the strut or the bottom. Typically, the contact point on a straight-sided load block tends to load the bottom of the strut, even when there is only a small amount of deflection. Consequently, the chain-belt centerlines at the span between the pulleys tilt, or become inclined, relative to the centerline planes of the pulleys. This tilt, or chain-belt misalignment, can cause uneven load distribution on the chain-belt, with associated wear and fatigue effects, and contribute to undesirable noise generation. However, the inventor has found that by utilizing a crowned face on the strut, the point of contact remains constant within reasonable amounts of sheave deflection.

### SUMMARY OF THE INVENTION

Briefly stated, a compression belt for a CVT having multiple variable pulleys comprises a plurality of interconnected load blocks, each having a unitary construction and a crowned strut edge for contacting and mechanically linking the pulleys of the CVT, wherein the radius of the crown is determined by the maximum allowable contact stress of the material from which the strut is manufactured, and the radius is located such that the contact point of the strut with the pulley remains close to the rocking radius of the strut.

### BRIEF DESCRIPTION OF THE DRAWING

FIG. 1 is a front view of a CVT belt strut, with the crowned strut edge of the invention exaggerated for effect.

FIG. 2 shows a CVT belt strut of the invention, in use in a variable pulley.

### DETAILED DESCRIPTION OF THE INVENTION

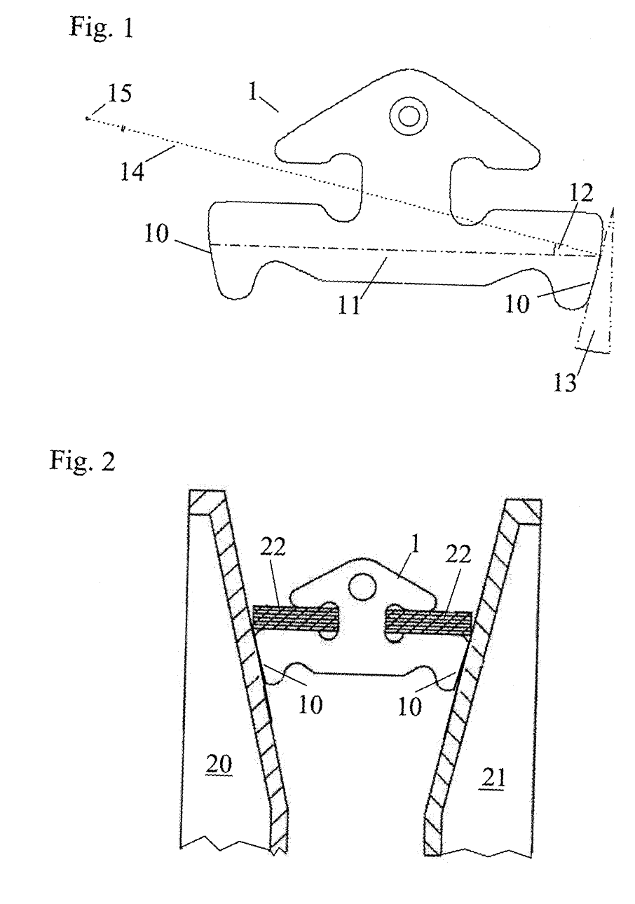

FIG. 2 shows an embodiment of the present invention. The invention is a compression or push-type chain-belt having a plurality of interconnected struts or load blocks 1, wherein the blocks have a crowned edge 10 for contacting and mechanically linking the pulleys of a continuously variable transmission (CVT). Note that the crowned edge is somewhat difficult to see in FIG. 2, and has been exaggerated in FIG. 1, which will be discussed below. The struts 1 are held together against outward movement by flexible laminated steel bands 22, which form the independent struts 1 into a belt, and the “T” shaped upper part of the struts hold the bands, preventing movement inward when the blocks are between the pulleys. The crowned contact surface 10 of the load blocks 1 engages the inner faces of the pulley sheaves 20 and 21, such that the crown is constant with respect to its tension member, and transmits torque by friction.

FIG. 1 shows a detail of a single load block or strut 1. The angle 13 shows the angle of taper of the sheaves in the variable pulley which will drive the belt of the invention in a CVT (relative to a line perpendicular to the axis of rotation of the sheaves 20 and 21). The load edges 10 of the strut 1 are “crowned”, or formed in an arcuate shape, along an arc with a radius shown by line 14, pivoting around point 15, and intersecting pitch line 11 at an angle 12. As has been indicated by the break lines on FIG. 1, in a preferred embodiment line 14 is, in fact, much longer than shown, and the crowning is much less evident. On a practical embodiment of the strut 1 in accordance with the invention, where the strut is approximately 24 mm (0.934″) wide, the radius of curvature (length of line 14) would be approximately 203 mm (8″). In this embodiment, angle 12 is approximately 11°. The strut is symmetrical, so the opposite surface 10 is crowned in the same way along its own radius of curvature (not shown).

The radius 14 of the crowned edge 10 is determined by the maximum allowable contact stress of the material from which the block is manufactured. The crown is located such that the contact point between the strut and the pulley is as close to the rocking radius of the strut as possible. As the strut is loaded, the contact patch increases, however the centroid of the contact patch remains substantially at the same point. Similarly, considering sheave and strut deflection, the contact patch centroid remains substantially at the same point.

Thus, the invention provides an improvement over the prior art, as the contact points on a compression belt having straight-sided load blocks tend to load the bottom of the strut, even when only a small amount of deflection occurs. Consequently, the chain centerlines at the span between the pulleys tilt, or become inclined, relative to the centerline planes of the pulleys. This tilt, or misalignment, can cause uneven load distribution on the chain, with associated wear and fatigue effects, and contribute to undesirable noise generation. The improvement of the present invention results in less undesirable tilting of the load blocks, as described above, thereby reducing the foregoing negative effects.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A compression belt for a CVT having multiple variable pulleys, comprising:
a) a plurality of interconnected load blocks, each block being of unitary construction;
b) said blocks having a crowned strut edge for contacting and mechanically linking said pulleys of said CVT, such that said crown is constant with respect to its tension member, wherein;
i) a radius of said crown is determined by a maximum allowable contact stress of a material from which said strut is manufactured; and
ii) said radius is located such that a contact point of said strut with said pulley remains close to a rocking radius of said strut.

2. In a CVT comprising multiple variable pulleys and a compression belt having a plurality of load blocks of unitary construction, a method for reducing tilting or misalignment of the centerlines of said compression belt, relative to the centerline planes of said pulleys, comprising the step of:
a) providing said blocks with a crowned strut edge for contacting and mechanically linking said pulleys of said CVT, such that said crown is constant with respect to its tension member, wherein;
i) a radius of said crown is determined by a maximum allowable contact stress of a material from which said strut is manufactured; and
ii) said radius is located such that a contact point of said strut with said pulley remains close to a rocking radius of said strut.
